(19) United States
(12) Patent Application Publication
(10) Pub. No.: US 2003/0114205 A1
(43) Pub. Date: Jun. 19, 2003

(54) Electronic device and method for controlling an operation of the electronic device

(76) Inventor: Makoto Yamashita, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 10/235,780

(22) Filed: Sep. 6, 2002

(30) Foreign Application Priority Data
Dec. 19, 2001 (JP) 2001-386274

(51) Int. Cl. H04B 1/38; H04M 11/10

(52) U.S. Cl. 455/574; 455/412; 455/41

(57) ABSTRACT

An electronic device is configured to be wholly controlled by an engine unit. The engine unit includes a work memory for a CPU and a DRAM utilized as a cache memory for a data memory unit. The data memory unit has a sleep function for power saving. When a data read/write request is made under a sleep mode of the data memory unit, the engine unit decides whether or not the data read/write processing can be performed in the cache area of the DRAM and, if the engine unit decides that it can be performed, the read/write processing is performed in the cache area only of the DRAM without returning the data memory unit from its sleep mode.

### CROSS-REFERENCE TO RELATED APPLICATIONS

This application is based upon and claims the benefit of priority from the prior Japanese Patent Application No. 2001-386274, filed Dec. 19, 2001 the entire contents of which are incorporated herein by reference.

### BACKGROUND OF THE INVENTION

1. Field of the Invention

The present invention relates to a battery-drivable type electronic device having a wireless communication function based on, for example, the Bluetooth standard and a method for controlling the operation of the electronic device and, in particular, an electronic device capable of largely reducing dissipation power relating to data access and a method for controlling the operation of the electronic device.

2. Description of the Related Art

In recent years, many techniques have been developed so as to eliminate cumbersome connections by means of wireless interface by which the passing of data is achieved between an information processing device, such as a personal computer, a PDA (Personal Digital Assistant) and a digital camera, on the one hand, and a peripheral device such as a printer on the other hand. By doing so it is possible to enhance user-friendliness. Further, the information processing devices are also connected together through a wireless interface, so that data transfer and data sharing can be achieved.

Recently, the development of an external memory device has also been actively under way, the device having the so-called wireless communication function to pass data to and from an information processing device through such an interface.

Incidentally, the existing external memory device having a wireless communication function is initially considered as being installed in a room and the power of its operation is obtained from a commercial power supply through an AC adapter. It is true that various measures have been adopted to save electric power at standby time, but no appreciably effective measure has thus far been taken at the time of data access. Further, it is not currently urgently necessary to do so.

On the other hand, recording media loaded into, for example, a digital camera have been made larger in capacity and, in this case, a cumbersome operation, such as their replacement, is unavoidably required so as to store much data. Therefore, there is a growing demand for, for example, a pocketable memory device, that is, a battery-powered type wireless communication function-equipped memory device.

In such a battery-powered memory device, the power saving of the battery is an important matter and it is preferable to fully consider the saving of power at the time of a data access.

### BRIEF SUMMARY OF THE INVENTION

The present invention has been achieved with such situations in view and the embodiments of the present invention provide, an electronic device capable of reducing dissipation power involved in data access and a method for controlling the operation of the electronic device.

In one aspect of the present invention, there is provided an electronic device comprising a first memory which store data; a second memory which temporarily store the data of the first memory to consume less power than the first memory; and a control unit configured to write data stored the second memory into the first memory and clears the second memory and write received data into the second memory, when there exists no available area great enough to allow the received data to be written into the second memory.

In the electronic device of the present invention, the so-called cache memory is utilized not only to reduce response time but also to save electric power. At the time of generating an individual write request, the data is written into the cache memory only without driving the hard disk, etc. By doing so, it is possible to achieve power saving at a time of data access.

In another aspect of the present invention, there is provided an electronic device having a sleep function to effect a shift to a power saving state when no access is made beyond a predetermined time, comprising a first memory which store data; a second memory which temporarily store the data of the first memory to consume less power than the first memory; and an control unit configured to write received data into the second memory while continuing the operation of the sleep function, when any available area for the received data to be written exists in the second memory.

In the electronic device of the present invention, the returning condition from the sleep mode is set not to a time when a simple access request is generated but to a time when, more strictly, a need to drive a hard disc, etc., arises in a situation not handleable by the simple cache memory. By doing so, it is possible to achieve power saving at the time of data access.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing available environments for an electronic device according to an embodiment of the present invention;

FIG. 2 is a block diagram showing an arrangement of the electronic device of the present invention;

FIG. 3 is a main flowchart showing an operation process of the electronic device of the present invention;

FIG. 4 is a flowchart showing an operation process of corresponding data read processing by the electronic device of the present embodiment;

FIG. 5 is a flowchart showing an operation process of corresponding received data write processing by the electronic device of the present embodiment; and

FIG. 6 is a flowchart showing an operation process of time-out processing by the electronic device of the present embodiment.

### DETAILED DESCRIPTION OF THE INVENTION

The embodiment of the present invention will be described below with reference to the accompanying drawing.

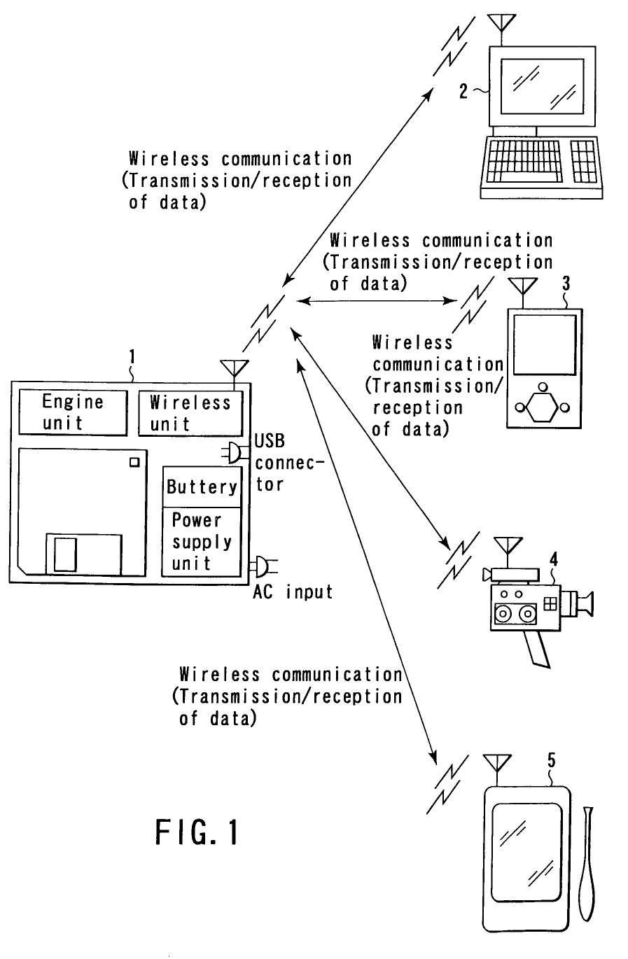

FIG. 1 is a view for explaining each available environment of an electronic device according to an embodiment of the present invention.

As shown in FIG. 1, this electronic device 1 constitutes a battery-powered, wireless-communication-function-equipped electronic device which carries out wireless communication with an information device such as a personal computer 2, a portable game machine 3, a digital video camera 4 and a PDA. Between the electronic device 1 on the one hand and these information devices 2 to 5 on the other hand, a Bluetooth module is provided by which data communication is carried out wirelessly.

The distance over which the wireless communication is done through the Bluetooth module is about 100 m maximum. And when the electronic device 1 and information devices 2 to 5 approach each other within this distance, a Bluetooth link is automatically created to allow the passing of data from one to the other.

The electronic device 1 has a USB connector to which a USB cable is connected and it also has a wired communication function to make wired data communication through the USB connector.

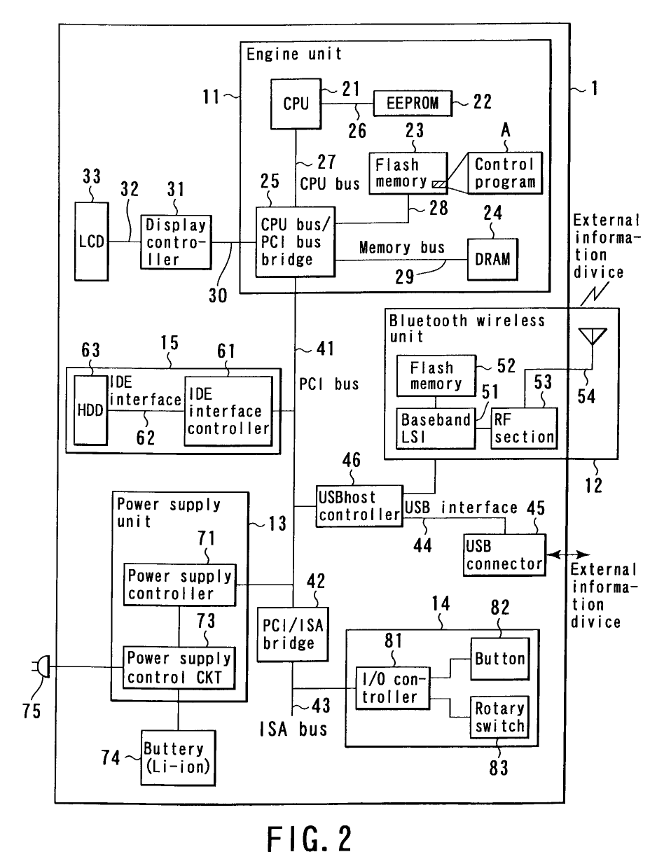

FIG. 2 is a block diagram showing an arrangement of the electronic device 1.

As shown in FIG. 2, the electronic device 1 has an engine unit 11, a Bluetooth wireless unit 12, a power supply unit 13, a setting operation unit 14 and a data memory unit 15.

The engine unit 11 controls the electronic device 1 as a whole and a CPU 21 serving as its nucleus is connected through a bus 26 to an EEPROM 22.

The CPU 21 is connected through a CPU bus 27 to a CPU bus/PCI bus bridge 25. A flash memory 23 is connected through a memory bus 28 to the CPU bus/PCI bus bridge 25 which is, in turn, connected to a DRAM 24 through a memory bus 29.

The flash memory 23 stores various kinds of programs each describing an operation process of the CPU 21 including a control program A for largely reducing dissipation power relating to data access, that is, a feature of this electronic device 1. On the other hand, the DRAM 24 is utilized as a working memory of the CPU 21. Further, the DRAM 24 is also utilized as a cache memory for the data memory unit 15.

The CPU bus/PCI bus bridge 25 constitutes an interface bridge between the CPU bus 27 and the PCI bus 41 and is connected through the bus 30 to a display controller 31. The display controller 31 is connected through a bus 32 to an LCD 33 and effects the display control of the LCD 33.

The PCI bus 41 is connected through a PCI/ISA bridge 42 to the ISA bus 43. The PCI bus 41 is connected through a USB host controller 46 to the Bluetooth wireless unit 12 and to the USB interface 44. To the USB interface 44 is connected a USB connector 45 for cable-connection to the information device.

The Bluetooth wireless unit 12 comprises a baseband LSI 51 connected to the USB host controller 46 and configured to control the Bluetooth wireless function, a flash memory 52 for storing a program run under the baseband LSI 51, an antenna 54, and an RF unit 53 connected between the baseband LSI 51 and the antenna 54 and configured to control a high-frequency signal therebetween.

Further, the data memory unit 15 is connected to the PCI bus 41 and has an IDE interface controller 61 connected through the PCI bus 41 and a hard disk 63 connected through the IDE interface controller 61. Further, the data memory unit 15 has a sleep function to save electric power and is configured to effect switching between two modes, that is, a normal mode in which, upon receipt of power from the power supply unit 13, the writing/reading of data can be promptly effected based on an instruction from the engine unit 11 and a sleep mode in which the power supply from the power supply unit 13 is interrupted and, for the writing/reading of data, it is necessary to regain the normal mode.

Further, the power supply unit 13 is connected to the PCI bus 41 and comprises a power supply controller 71 connected to the PCI bus 41 and a power supply control circuit 73 connected to the power supply controller 71. To the power supply control circuit 73 a battery 74 and AC input 75 are connected. In the case where the electronic device 1 is used in a mobile environment, the power is supplied from the battery 74. While, on the other hand, the battery 74 is being charged and the device is used under an AC drivable environment, the power is supplied from the AC input 75. The power from the battery 74 and that from the AC input 75 are supplied to those elements necessary to the operation of the electronic device 1, such as the engine unit 11, wireless unit 12 and data memory unit 15.

Further, to the ISA bus 43 the setting operation unit 14 is connected. The setting operation unit 14 includes an I/O controller 81 connected to the ISA bus 43 as well as a button 82 and rotary switch 83 connected to the I/O controller 81. The button 82 and rotary switch 83 are used for the setting of the operation environment of the electronic device and the starting of the device 1.

An explanation will be made below about the power saving control at a time of data access by the electronic device 1 thus structured.

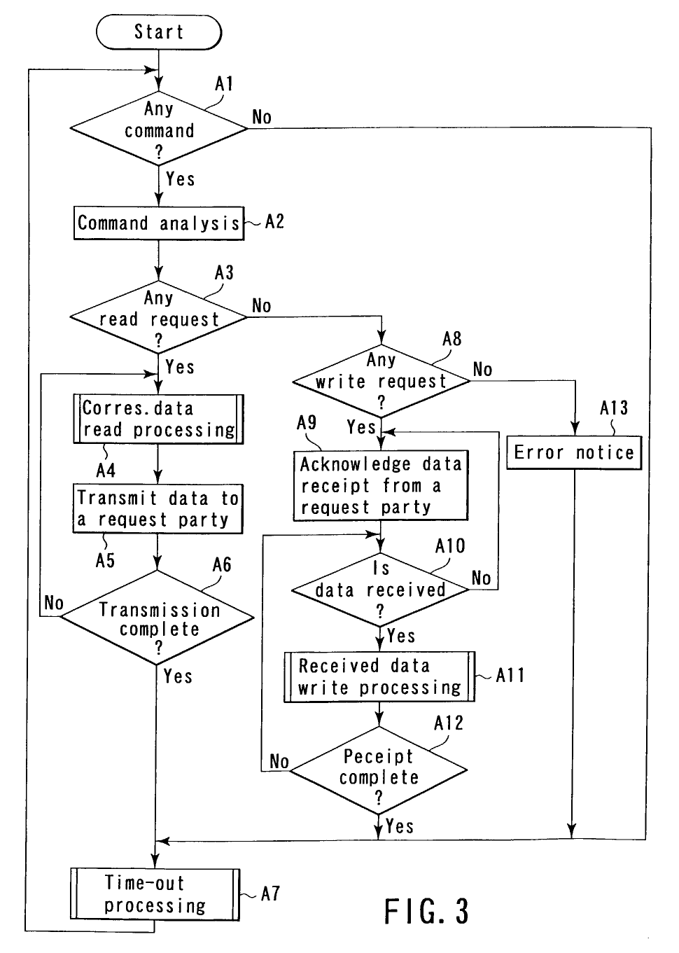

FIG. 3 is a main flowchart showing the operation process of the electronic device 1.

When the reception of any command from the Bluetooth wireless unit 12 is notified (YES at step A1), then the engine unit 11 effects its command analysis (step A2).

If this command is a read request (YES at step A), the engine unit 11 performs corresponding data read processing as will be later described (step A4) and instructs the Bluetooth wireless unit 12 to transmit the read data to the requesting party (step A5). After the completion of this transmission (YES at step A6), the engine unit 11 performs time-out processing (step A7) as will be later described and waits for the reception of the next command.

If, on the other hand, this command is a write request (NO at step A3, YES at step A8), the engine unit 11 asks the Bluetooth wireless unit 12 as to whether or not the corresponding data is being received from the request partner and acknowledges it (step A9). If the data reception is acknowledged (YES at step A10), the engine unit performs received data write processing as will be described below (step A11). If all the data have been received and written (YES at step A12), the engine unit 11 performs time-out processing (step A7) as will be set out below and waits for the reception of the next command.

If the command is neither a read request nor a write request (NO at step A3 and NO at step A8), the engine unit 11 instructs the Bluetooth wireless unit 12 to transmit an error notice to the requesting party (step A13) and, after the later-described time-out processing has been performed (step A7), waits for the reception of the next command.

As long as no reception of any command is notified from the Bluetooth wireless unit 12 (NO at step A1), the engine unit 11 performs later-described time-out processing repeatedly for a predetermined time interval (step A7).

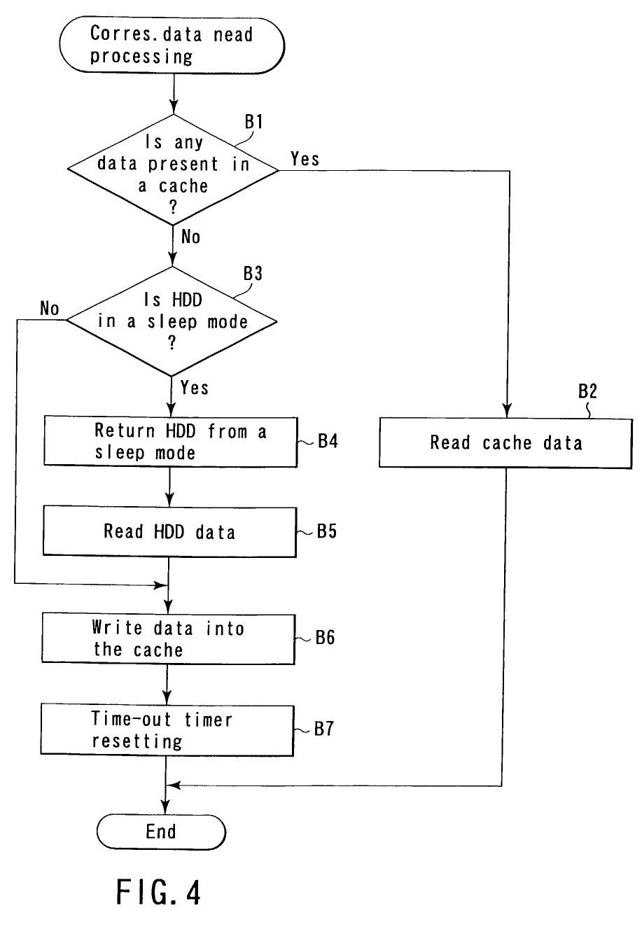

FIG. 4 is a flowchart showing the operation process of the corresponding data read processing of the electronic device 1.

At the time of this corresponding data read processing, the engine unit 11 checks the DRAM 24 to see whether or not any such data is present (step B1). If the data is present in the DRAM 24 (YES at step B1), the engine unit 11 reads out the data present in the DRAM 24 (step B2) and ends the corresponding data read processing.

If, on the other hand, no such data is present in the DRAM 23 (NO at step B1), the engine unit 11 now checks whether or not the data memory unit 15 is in a sleep mode (step B3). If it is in a sleep mode (YES at step B3), the engine unit 11 returns the data memory unit 15 from the sleep mode back to the normal mode (step B4).

After this, the engine unit 11 instructs the data memory unit 15 to read out requested data (step B5) and allows the read-out data to be written into the DRAM 24 (step B6). Also, the engine unit 11 resets a time-out timer (step B7) and ends this data read processing.

That is, in the corresponding data read processing, the electronic device 1 never operates the data memory unit 15 in the case where the requested data is present in the DRAM 24. Further, the electronic device 1 never returns the data memory unit 15 from the sleep mode back to the normal mode in the case where the data memory unit 15 is in the sleep mode.

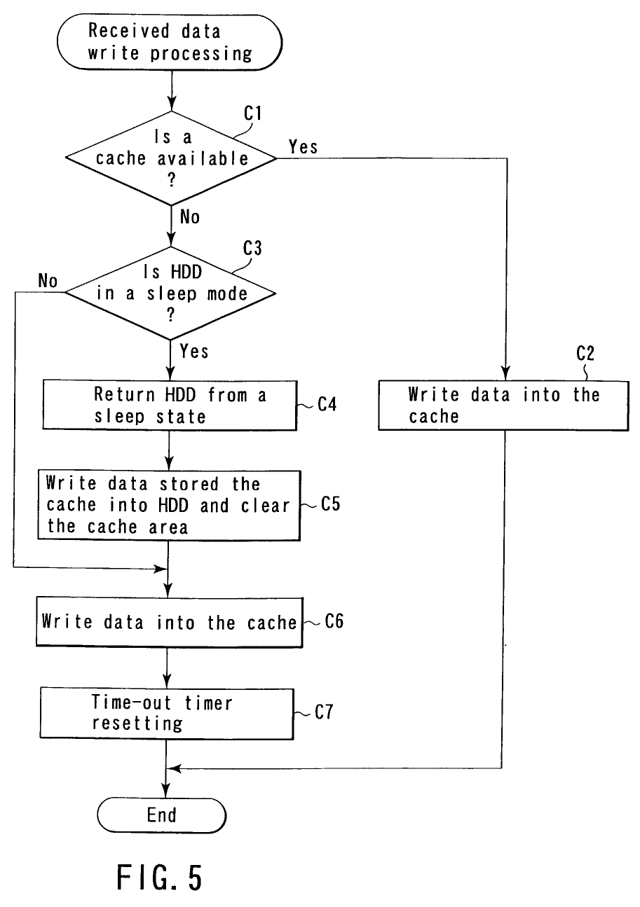

FIG. 5 is a flowchart showing an operation process of received data write proceeding.

At a time of the received data write processing, the engine unit 11 checks whether or not there exists available area great enough to allow the data to be written into a cache area secured in the DRAM 24 (step C1). If there exists any available area (YES at step C1), the engine unit 11 writes the data into the available area (step C2) and ends the received data write proceeding.

If, on the other hand, there exists no available area great enough to allow the data to be written (NO at step C1), the engine unit 11 now checks whether or not the data memory unit 15 is in the sleep mode (step C3). If it is in the sleep mode (YES at step C3), the engine unit 11 returns the data memory unit 15 from the sleep mode back to the normal mode (step C4).

After this, the engine unit 11 transfers data which fills the cache area of the DRAM 24 to the data memory unit 15 and gives a write instruction. The engine unit 11 clears the cache area of the DRAM 24 (step CS) and writes received data into the DRAM 24 (step C6). Also the engine unit 11 resets the time-out timer (step C7) and ends the corresponding data read processing.

When, in the received data write processing, the electronic device 1 never operates the data memory unit 15 in the case where available area great enough to write the received data exists in the DRAM 24 and never returns the data memory unit 15 from the sleep mode to the normal mode in the case where the data memory unit 15 is in the sleep mode.

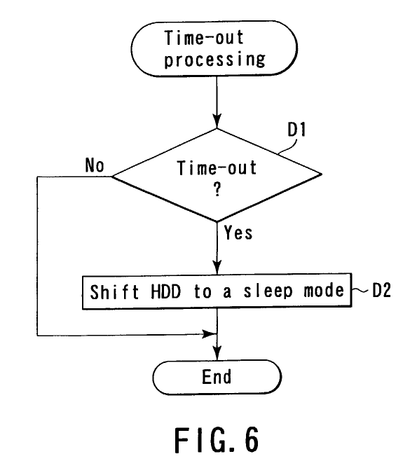

FIG. 6 is a flowchart showing an operation process of time-out processing of the electronic device 1. The engine unit 11 switches the data memory unit 15 from the normal mode to a sleep mode (step D2) at a time of the immediately previous time-out timer resetting, that is, when a predetermined time passes just after the reading out of the data from the data memory unit 15 or just after the writing of the data into the memory unit (step D1).

Thus, the electronic device 1 can largely reduce dissipated power relating to the data access.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic device comprising:
a first memory which store data;
a second memory which temporarily store the data of the first memory to consume less power than the first memory; and
a control unit configured to write data stored the second memory into the first memory and clears the second memory and write received data into the second memory, when there exists no available area great enough to allow the received data to be written into the second memory.

2. An electronic device having a sleep function to effect a shift to a power saving state when no access is made beyond a predetermined time, comprising:
a first memory which store data;
a second memory which temporarily store the data of the first memory to consume less power than the first memory; and
a control unit configured to write received data into the second memory while continuing the operation of the sleep function, when any available area for the received data to be written exists in the second memory.

3. The electronic device according to claim 2, wherein the control unit reads requested data from the second memory while continuing the operation of the sleep function, when the requested data exists in the second memory.

4. An electronic device capable being driven by a battery, comprising:
a communication unit configured to make communication to transmit and receive data;
a first memory which store data;
a second memory which temporarily store the data of the first memory to consume less power than the first memory; and
a control unit configured to write data stored the second memory into the first memory and clears the second memory and write data received by the communication unit into the second memory, when there exists no available area great enough to allow the received data to be written into the second memory.

5. An electronic device capable of being driven by a battery and having a sleep function to effect a shift to a power saving state when no access is made beyond a predetermined time, comprising:
a communication unit configured to make communication to transmit and receive data;
a first memory which store data;
a second memory which temporarily store the data of the first memory to consume less power than the first memory; and
a control unit configured to write data received by the communication unit into the second memory while continuing the operation of the sleep function, when any available area for the received data to be written exists in the second memory.

6. The electronic device according to claim 5, wherein the control unit reads data requested via the communication unit from the second memory while continuing the operation of the sleep function, when the requested data exists in the second memory.

7. A method for controlling an operation of an electronic device having a first memory which store data and a second memory which temporarily store the data of the first memory to consume less power than the first memory, comprising:
writing data stored the second memory into the first memory and clears the second memory when there exists no available area great enough to allow received data to be written into the second memory; and
writing the received data into the second memory.

8. A method for controlling an electronic device having a first memory which store data and a second memory which temporarily storing the data of the first memory to consume less power than the first memory and having a sleep function to effect a shift to a power saving state when no access is made beyond a predetermined time, comprising;
writing received data into the second memory while continuing the operation of the sleep function, when any available area for the received data to be written exists in the second memory.

9. The method according to claim 8, further comprising: reading requested data from the second memory while continuing the operation of the sleep function, when the requested data exists in the second memory.

10. A method for controlling a battery-drivable electronic device having a communication unit configured to make communication to transmit and receive data, a first memory which store data and a second memory which temporarily store the data of the first memory to consume less power than the first memory, comprising:
writing data stored the second memory into the first memory and clears the second memory when there exists no available area great enough to allow data received by the communication unit to be written into the second memory; and
writing the received data into the second memory.

11. A method for controlling an operation of a battery-driven electronic device having a communication unit configured to carry out communication to transmit and receive data, a first memory which store the data and a second memory which temporarily store the data of the first memory to consume less power than the first memory and having a sleep function to effect a shift to a power saving state when no access is made beyond a predetermined time, comprising:
writing data received by the communication unit into the second memory while continuing the operation of the sleeve function, when any available area for the received data to be written exists in the second memory.

12. The method according to claim 11, further comprising: reading data requested via the communication unit from the second memory while continuing the operation of the sleep function, when the requested data exists in the second memory.
